(19) United States
(12) Patent Application Publication
(10) Pub. No.: US 2026/0116421 A1
(43) Pub. Date: Apr. 30, 2026

(54) METHOD AND DEVICE FOR CONTROLLING AUTONOMOUS DRIVING BASED ON CONTEXTUAL INFORMATION

(71) Applicant: Kakao Mobility Corp., Gyeonggi-do (KR)

(72) Inventor: Seung Hwan HONG, Gyeonggi-do (KR)

(21) Appl. No.: 18/970,021

(22) Filed: Dec. 5, 2024

(30) Foreign Application Priority Data
Oct. 28, 2024 (KR) 10-2024-0148206

(51) Int. Cl. B60W 60/00; G01C 21/34

(52) U.S. Cl. CPC B60W 60/001; G01C 21/3415

(57) ABSTRACT

There is provided an autonomous driving control method based on contextual information. The method includes determining destination information for a user’s mobile object; determining autonomous driving performance information of the mobile object; setting a global path to the destination; generating a first driving scenario for the global path, and determining environment information based on the first driving scenario and traffic situation information about a traffic volume on the global path; setting a local path by reflecting the autonomous driving performance information, information on the global path, the environment information, and the traffic situation information; configuring a second driving scenario by reflecting the local path in the first driving scenario, and determining an autonomous driving execution module including a plurality of sub-models corresponding to the second driving scenario; and controlling autonomous driving of the mobile object using the autonomous driving execution module.

### CROSS-REFERENCE TO RELATED APPLICATIONS

This application claims priority under 35 U.S.C. § 119(b) to Korean Application No. 10-2024-0148206, filed on October 28, 2024, the disclosure of which is incorporated herein by reference in its entirety.

### TECHNICAL FIELD

The present disclosure relates to a method and device for autonomous driving of a mobile object, and more specifically, to a method and device for providing an autonomous driving module and data suitable for a driving environment.

This work was supported by Institute of Information & communications Technology Planning & Evaluation (IITP) grant funded by Korea government (MSIT) (No. 2710008754, Development of Cloud-Native Key Technologies to Collect and Provide Integrated Training Dataset for Autonomous Driving System).

### BACKGROUND

Autonomous driving mobile objects are developed in various mobility fields of automobiles, robots, unmanned mobile devices, drones, and the like, and commercialization thereof is in pursuit.

As the range of autonomous driving applications expands, the demand for accurate and flexible map information is increasing. Individually providing or generating map information suitable for various devices from unmanned drones to autonomous vehicles is accompanied with a lot of difficulties, and this variety may cause inefficiency and operational fragmentation.

In addition, the autonomous vehicle may establish a driving plan and perform a planning process referring to a preset path of the map, and the autonomous vehicle may predict expected paths of surrounding objects referring to their moving paths. However, when actual moving paths of the mobile object and surrounding objects are different from preset moving paths, the mobile object may malfunction or cause an accident.

Autonomous driving systems are developing recognition, planning, and control software(SW), high-definition maps (HD Map), AI training data, and the like through various tests to prevent malfunctions or accidents of the mobile object, and installs these in autonomous driving computing devices to deliver services.

Although it is essential to essential to provide software tailored to each driving scenario to enable autonomous mobile objects to operate in irregular and complex urban environments, such as during traffic accidents or road construction, current systems have limitations of operating in a state separated from each other and functioning solely in predefined scenarios.

There is a problem in that autonomous driving modules should be trained with limited rare-case or edge-case data in an irregular driving environment, and since it is difficult to secure sufficient rare case data, it is not easy for the autonomous driving modules to learn how to respond to the rare cases.

### SUMMARY OF THE INVENTION

As the data and autonomous driving modules used in operation of autonomous mobile objects are getting more complicated and their scale is growing larger, it needs to provide data and autonomous driving modules that efficiently support autonomous driving by integrating the accompanying data and autonomous driving modules with driving paths and contextual information.

An object of the present disclosure is to provide an autonomous driving control method and device, in which an autonomous driving system may analyze environments changing in real time based on a driving path and contextual information and determine a path adaptive to dynamic environments.

The technical problems to be solved in the present disclosure are not limited to the technical problems mentioned above, and unmentioned other technical problems will be clearly understood by those skilled in the art from the flowing description.

In accordance with an aspect of the present disclosure, there is provided an autonomous driving control method based on contextual information, the method comprises: determining destination information on a destination to move to through a mobile object of a user for a user’s mobile object; determining autonomous driving performance information indicating an autonomous driving performance of the mobile object; setting a global path to the destination on the basis of based on the destination information; generating a first driving scenario for the global path, and determining confirming environment information based on the first driving scenario and traffic situation information about a traffic volume on the global path; setting a local path by reflecting the autonomous driving performance information, information on the global path, the environment information, and the traffic situation information; configuring a second driving scenario by reflecting the local path in the first driving scenario, and determining confirming an autonomous driving execution module including a plurality of sub-models corresponding to the second driving scenario; and controlling autonomous driving of the mobile object using the autonomous driving execution module including the plurality of sub-models.

The setting a global path may include confirming a movement pattern or a preference of the user corresponding to the destination information of the user using a global path learning model that has learned the movement pattern or preference of the user based on driving data and location information of the user; and setting the global path reflecting the movement pattern or preference of the user corresponding to the destination information of the user.

The determination of environment information and traffic situation information may include collecting information collected through a plurality of sensor units provided in the mobile object; and converting the collected data into a text, and configuring the contextual information using the text information.

The configuring contextual information may include inputting the text information into a chain-of-thought analysis model and determining a path plan based on a driving scenario output from the chain-of-thought analysis model.

The configuring contextual information may include inputting the text information into a language model, and determining information on traffic reports, accident updates, and changes in road conditions analyzed and output in a form of natural language through the language model.

The environment information may include at least one among external source data including at least one among data on road congestion information, accident occurrence information, and the like provided by an Intelligent Transport System (ITS), and weather data provided by a weather information system, high-definition map (HD Map) data including at least one among location of lanes, traffic lights, road signs, and intersection configurations, and driving data including nodes of the high-definition map data or links connecting the nodes, and polygons indicating roads or lane areas.

The determining environment information and traffic situation information may include organizing the external source data, high-definition map data, and driving data into a multidimensional structure: converting the multidimensional data into a multi-layered vector format; and connecting the converted data of a vector format of multi-layer by defining a mutual topological relation.

The setting the local path may include integrating the autonomous driving performance information, information on the global path, the environment information, and the traffic situation information; generating at least one candidate local path based on the integrated information; and selecting one of the at least one candidate local path, and determining the selected path as the local path.

The determining the selected path as the local path may include determining dynamic event information among the environment information and the traffic situation information, and selecting one of at least one candidate local path based on the dynamic event information.

The method further comprises requesting at least one among the plurality of sub-modules corresponding to the second driving scenario to a local server or a central server connected to the mobile object; receiving at least one of the requested sub-modules from the local server or the central server connected to the mobile object; and updating at least one of the received sub-modules in the autonomous driving execution module, and loading the updated autonomous driving execution module on the mobile object.

The requesting at least one among the plurality of sub-modules may include inputting the environment information and the traffic situation information into a metadata recording model, and determining metadata output from the metadata recording model; and requesting at least one among the plurality of sub-modules using the determined metadata.

The method further comprises generating a virtualized driving situation by inputting the autonomous driving performance information, the environment information, and the traffic situation information into a generative learning model, and collecting virtual environment information and virtual traffic situation information corresponding to the generated virtualized driving situation.

The setting the local path may include setting the local path by further reflecting the virtual environment information and virtual traffic situation information.

In accordance with another aspect of the present disclosure, there is provided an autonomous driving control device based on contextual information, the device comprises: a communications unit for exchanging data with a mobile object; a memory for storing at least one instruction; and a processor for executing the at least one instruction stored in the memory using the data, wherein the processor is configured to determine destination information for a user’s mobile object, determine autonomous driving performance information indicating an autonomous driving performance of the mobile object, set a global path to the destination based on the destination information, generate a first driving scenario for the global path, and determine environment information based on the first driving scenario and traffic situation information about a traffic volume on the global path, set a local path by reflecting the autonomous driving performance information, information on the global path, the environment information, and the traffic situation information, configure a second driving scenario by reflecting the local path in the first driving scenario, and determine an autonomous driving execution module including a plurality of sub-models corresponding to the second driving scenario, and control autonomous driving of the mobile object using the autonomous driving execution module including the plurality of sub-models.

### BRIEF DESCRIPTION OF THE DRAWINGS

FIG. 1 is a diagram illustrating a mobile object transmitting and receiving data by communicating with a server and other devices.

FIG. 2 is a block diagram of a mobile object illustrated in this disclosure.

FIG. 3 is a block diagram of a local server according to an embodiment of the present disclosure.

FIG. 4 is a block diagram of a central server according to an embodiment of the present disclosure.

FIG. 5 is a block diagram showing the configuration of an autonomous driving module according to an embodiment of the present disclosure.

FIG. 6 illustrates a driving scenario set in a chain-of-thought analysis model equipped in the autonomous driving module according to an embodiment of the present disclosure.

FIGS. 7A and 7B are flowcharts illustrating the operation of a central server and a local server in providing the autonomous driving modules in an autonomous driving system according to an embodiment of the present disclosure.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

The terms such as '….unit' and '….group' as used below refer to a unit that processes at least one function or motion, and may be implemented as a hardware, a software, or a combination of the hardware and the software.

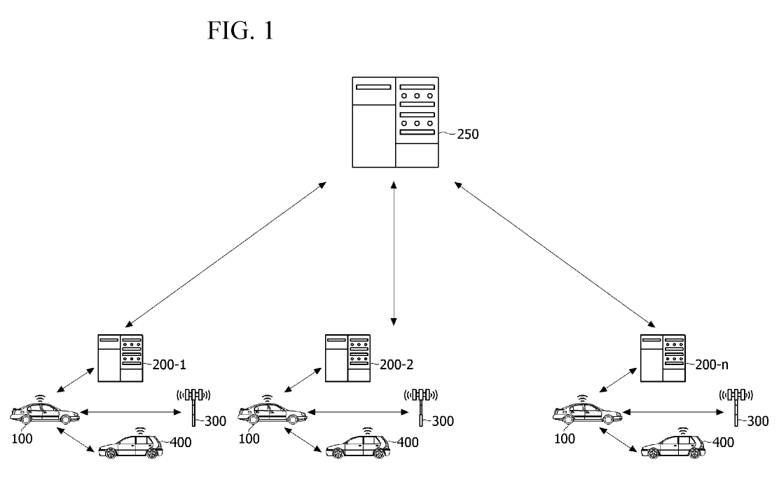

Hereinafter, a method and device for operating an adaptive autonomous driving system will be described with reference to FIGS. 1 to 3.

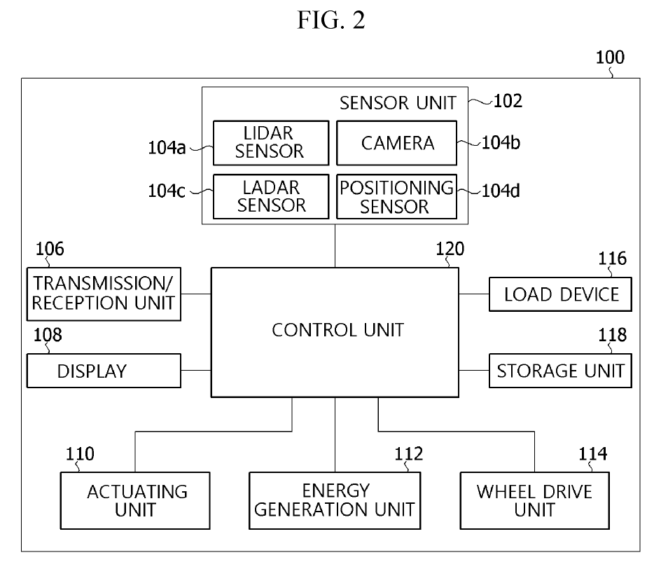

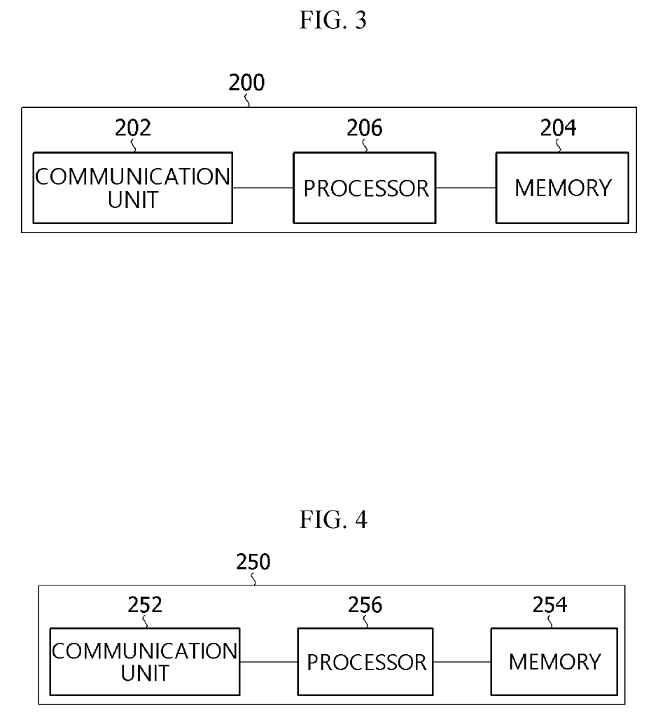

FIG. 1 is a diagram illustrating a mobile object transmitting and receiving data by communicating with a server and other devices, FIG. 2 is a block diagram of a mobile object illustrated in this disclosure, and FIG. 3 is a block diagram of a local server according to an embodiment of the present disclosure.

Referring to FIG. 1, a mobile object 100 may be a mobility device designed for a specific applications and capable of moving on the ground, in the air, or at the sea. The mobile object 100 may include various forms of vehicles such as robots, drones, or ships. The mobile object 100 may be, for example, a mobility device that implements autonomous movement by communicating with local servers 200-1, 200-2, and 200-n and other devices 300 and 400. The mobile object 100 may transmit various information acquired while driving, such as recognition information based on multiple sensors including cameras, LiDAR, radar, and the like, positioning information acquired through positioning sensors including GNSS, IMU, INS, wheel encoder, steering information, and the like, and environment information related to a moving path, to the local servers 200-1, 200-2, and 200-n, and the local servers 200-1, 200-2, and 200-n may transmit path information, map information, driving assistance information, and software to the mobile object 100 based on the information described above. As another example, the mobile object 100 may exchange the information described above by communicating with the local servers 200-1, 200-2, and 200-n and other devices 300 and 400, and acquire navigation information that guides to the moving path. In the present disclosure, the local servers 200-1, 200-2, and 200-n may operate as an autonomous driving support device that constructs path information for autonomous driving based on the behaviors of the mobile object 100 and recognition information and positioning information of object elements collected from the mobile object 100. To this end, the local servers 200-1, 200-2, and 200-n may store data used in the autonomous driving system and software modules for operating the autonomous driving system. In particular, the local servers 200-1, 200-2, and 200-n may perform learning or training, improvement, analysis, evaluation, and the like on the software modules for operating the autonomous driving system, and provide appropriate data and software modules to the autonomous driving system. In addition, the local servers 200-1, 200-2, and 200-n may support real-time updates of the software modules for operating the autonomous driving system.

The local servers 200-1, 200-2, and 200-n are connected through a central server 250 and may store data used in the autonomous driving system and software modules for operating the autonomous driving system in synchronization with the central server 250.

Hereinafter, in the embodiments of the present disclosure, the local servers 200-1, 200-2, and 200-n and the central server 250 may be described as servers 200-1, 200-2, 200-n, and 250 for convenience of explanation.

In present disclosure, it will be described mainly based on an example in which the mobile object 100 is a vehicle, this may also be applied to other types of mobile objects listed above. Hereinafter, for convenience of explanation, the mobile object 100 and the vehicle may be described interchangeably.

When the mobile object 100 is a vehicle, the mobile object 100 may be driven based on electric energy or fossil energy. In the case of electric energy, the mobile object 100 may be, for example, a pure battery-based vehicle driven only by a high-voltage battery or may employ a gas-based fuel cell as an energy source. In addition, the fuel cell may use various types of gas capable of generating electric energy, and the gas may be, for example, hydrogen. However, it is not limited thereto, and various gases may be applied. In the case of fossil energy, the mobile object 100 is driven based on fuel such as gasoline, diesel, liquefied gas, or the like, and may be provided with an engine that drives a wheel drive unit 114 by combustion of the fuel. The engine may be included in the energy generation unit 112 from the viewpoint of providing the driving rotational force of wheels to the wheel drive unit 114.

The mobile object 100 may be controlled to be driven autonomously, and autonomous driving may be implemented as semi-autonomous driving or full-autonomous driving. The full-autonomous driving may be provided as autonomous movement in which a control unit 120 of the mobile object 100 completely controls the right of control without intervention of a user even when the driving situation is uncertain. The semi-autonomous driving may be provided as autonomous movement that requires intervention of a driver according to a specific driving situation. The semi-autonomous driving may be implemented to allow a user to perform manual driving as the control unit 120 deactivates autonomous driving when the situation occurs and transfers the right of control to the user. Furthermore, the autonomous driving performance of the mobile object can be set differently depending on the performance or condition of the mobile object (100), and the autonomous driving performance can be set and stored. The autonomous driving performance of the mobile object can be included in and stored as autonomous driving performance information. For instance, the autonomous driving performance information may include at least one of information about the Operational Design Domain (ODD) or information about the Dynamic Driving Task (DDT).

Meanwhile, the mobile object 100 may communicate with other devices 200-1, 200-2, 200-n, 250, and 300 as well as with other mobile objects 500. Other devices may include, for example, servers 200-1, 200-2, 200-n, and 250 that support various controls, state management, and driving of the mobile object 100, infrastructure support devices 300, various types of user devices, and the like. The servers 200-1, 200-2, 200-n, and 250 may transmit data and software modules used for controlling the mobile object 100 to the mobile object 100 in response to the requests and data transmitted from the mobile object 100 and the user devices to support autonomous driving of the mobile object 100 and various services.

The infrastructure support device 300 may include a roadside unit, a smart traffic system, and a Dedicated Short-Range Communications (DSRC) system. In addition, the infrastructure support device 300 may include road facility devices that support autonomous driving, such as vehicle-to-vehicle communication, vehicle-to-infrastructure communication, a weather measurement device, an emergency situation driving support system, and the like. The infrastructure support device device 300 like ITS devices may collect data on the external environment and the mobile object in real time. The infrastructure support device 300 may exchange vehicle recognition data, driving control and state data, environmental data around the vehicle, map data, and the like with the mobile object 100 through V2I to assist self-driving of a user or support autonomous driving of the mobile object 100. The mobile object 100 may exchange the data listed above with other mobile objects 500 through V2V to support self-driving or autonomous driving.

The mobile object 100 may communicate with other vehicles or other devices based on cellular communication, Wireless Access in Vehicular Environment (WAVE) communication, Dedicated Short Range Communication (DSRC) or short-range communication, or other communication methods.

For example, the mobile object 100 may use LTE as a cellular communication network, a communication network such as 5G, a Wi-Fi communication network, a WAVE communication network, or the like for communication with the servers 200-1, 200-2, 200-n, and 250, the infrastructure support devices 300, or other mobile objects 500. As another example, DSRC or the like used in the mobile object 100 may be used for communications between vehicles. The communication methods between the mobile object 100, the servers 200-1, 200-2, 200-n, and 250, the infrastructure support devices 300, other mobile objects 500, and the user device are not limited to the embodiment described above.

Referring to FIG. 2, the mobile object 100 may include a sensor unit 102, a transmission/reception unit 106, and a display 108.

The sensor unit 102 may be provided with various types of detectors that detect various states and situations occurring in the external and internal environments of the mobile object 100 and grasp positioning information of the mobile object 100. That is, the sensor unit 102 may be configured as a multi-sensor module including different types of sensors and acquire sensing data detected by each sensor.

Specifically, the sensor unit 102 may be provided with an observation sensor to perceive dynamic and static objects existing around the mobile object 100, and a positioning sensor 104d to acquire location information and direction information of the vehicle. The observation sensor may be configured as a multi-sensor to have a LiDAR sensor 104a, a camera 104b functioning as an image sensor, and a radar sensor 104c. The sensor unit 102 may acquire sensor data including recognition information, positioning information, and the like by the sensors described above. The recognition information may include LiDAR data including three-dimensional recognition data of surrounding objects acquired by the LiDAR sensor 104a, two-dimensional image data of surrounding objects acquired by the camera 104b, and radar data detecting existence and movement states of surrounding objects.

The LiDAR sensor 104a may be a type of three-dimensional perception sensor according to the present disclosure. The LiDAR sensor 104a may be a sensor that observes surrounding environments and perceives the three-dimensional shape of an object based on laser scanning. Specifically, the LiDAR sensor 104a may acquire three-dimensional perception data on the surrounding environments and objects by radiating laser around the mobile object 100. The three-dimensional perception data may include a point cloud expressing the three-dimensional shape of an object, i.e., detection data, and observation image data that visually represents the surrounding environments. The detection data may be provided to identify each object by showing, for example, the three-dimensional outline shape of the object, arrangement of the object, and the like. The image data may be provided to identify the object and the surrounding environments through, for example, images of the object and the surrounding environments.

The camera 104b may acquire two-dimensional image data or image data having depth information on the environments and objects around the mobile object 100. The radar sensor 104c may radiate, for example, radio waves of a predetermined wavelength to the surroundings and detect behaviors of the objects based on the radio waves reflected from the objects. The behaviors of the objects may include, for example, existence of the objects and presence or absence of movement, the distance between the mobile object 100 and the objects, the speed of the objects, the direction of movement, and the like.

The positioning sensor 104d may be configured of a Global Navigation Satellite System (GNSS), an Inertial Measurement Unit (IMU), an Inertial Navigation System (INS), a wheel encoder, a steering sensor, or the like to confirm positioning information including its own position, driving posture, and speed.

In present disclosure, it is described mainly focusing on the sensors of the sensor unit 102 referred to in the description of the embodiment, and sensors that detect various situations not listed therein may be additionally included.

The transmission/reception unit 106 may support mutual communication with the servers 200, the infrastructure support devices 300, the surrounding mobile objects 500, and the like. In the present disclosure, the transmission/reception unit 106 may transmit data generated or stored while driving to the servers 200-1, 200-2, 200-n, and 250, and receive data and software modules transmitted from the servers 200-1, 200-2, 200-n, and 250. In the present disclosure, the mobile object 100 may transmit and receive data utilized in the method according to the present disclosure to and from the outside through the transmission/reception unit 106.

The display 108 may function as a user interface. The display 108 may display to output, by the control unit 120, the operation state and control state of the mobile object 100, path/traffic information, remaining energy information, contents requested by the driver, and the like. The display 108 may display various information related to the path information, map information, and driving paths transmitted from the servers 200. The display 108 is configured as a touch screen that can receive driver's input and requests of the driver directing the control unit 120.

Meanwhile, the mobile object 100 may include an actuating unit 110, an energy generation unit 112, a wheel drive unit 114, and a load device 116.

The actuating unit 110 is provided with at least one module that implements a driving operation, and may perform at least one driving operation among longitudinal control such as acceleration and deceleration and lateral control such as steering. The actuating unit 110 may be provided with pedals, a steering wheel, and the like that receive the request of the user for the control, and various operation modules to execute a driving operation in the wheel drive unit 114 according to the request.

The energy generation unit 112 may generate and supply power and electric power used in the driving power system such as the wheel drive unit 114 and the load device 116. When the mobile object 100 is driven based on electric energy, the energy generation unit 112 may be configured of, for example, an electric battery, or a combination of an electric battery and a fuel cell that charges the electric battery. When the mobile object 100 is driven based on fossil energy, the energy generation unit 112 may be configured as an internal combustion engine.

The wheel drive unit 114 may include a plurality of wheels, a driving force transmission module for generating and applying a driving force or transmitting a driving force to the wheels, a braking module for decelerating the wheels, and a steering module for realizing lateral control of the wheels. When the mobile object 100 is driven based on electric energy, the driving force transmission module may be configured as a motor module that generates the driving force based on electric power output from the electric battery. When the mobile object 100 operates based on fossil energy, the driving force transmission module may be provided with a transmission or a gear module for transmitting the power of the internal combustion engine.

The load device 116 may be an auxiliary device that is mounted on the mobile object 100 and consumes power supplied from the energy generation unit 112 or converted from the output of the energy generation unit 112 by use of a passenger or a user. The load device 116 may be a type of non-driving electric device excluding the driving power system such as the wheel drive unit 114 in the present disclosure. The load device 116 may be, for example, an air conditioning system, a lighting system, a seat system, and various devices installed in the mobile object 100.

In addition, the mobile object 100 may include a storage unit 118 and a control unit 120.

The storage unit 118 may store applications and various data for controlling the mobile object 100, and load applications or read and write data in response to the request of the control unit 120.

In the present disclosure, the storage unit 118 may store an application that generates real-time environment information based on the recognition information and positioning information acquired from the sensor unit 102 of the mobile object 100 and external information received from an external device. The recognition information and positioning information may be generated by recognizing behaviors of the mobile object 100 and object elements around the mobile object 100. The recognition information may include direct recognition information acquired by the mobile object 100 and indirect recognition information. The direct recognition information may be recognition information directly detected by the mobile object 100. The indirect recognition information may be recognition information detecting object elements that exceed the recognition range of the observation sensors 104a to 104c of the mobile object 100, and may be recognition information acquired from other mobile objects around the mobile object. The external device may be, for example, the servers 200-1, 200-2, 200-n, and 250, the infrastructure support devices 300, and/or surrounding mobile objects 500.

The object elements may include road objects and external objects. The road objects may include road static objects and road dynamic objects existing in an area where the mobile object 100 moves, e.g., the road. The road static objects may be, for example, marking information, facilities, and the like for traffic control on the road. The road dynamic objects may be movable objects that move in the lanes around the driving lane of the mobile object 100. The road dynamic objects may be, for example, vehicles moving in nearby lanes of the same or opposite direction, vehicles driving in each lane connected to an intersection, pedestrians/mobilities crossing a crosswalk, or the like. Although a vehicle is described as an example of the road dynamic object, the present invention is not limited thereto, and various types of ground mobilities moving on the road or a detailed lane of the road may correspond to the road dynamic objects.

The external objects may include static objects such as buildings installed outside the road, sidewalks, and the like, and dynamic objects such as pedestrians, bicycles, and the like moving around the road.

The environment information may be information related to the object elements around the mobile object inferred from the recognition information and positioning information. The information related to the object elements may include the type, position, shape, and moving trajectory of an object identified as an object element. The information related to the object elements may include a traffic flow state estimated from the behaviors of road dynamic objects, operation states of road traffic facilities recognized from the observation sensors 104a to 104c, events recognized from the observation sensors 104a to 104c, and the like.

In addition, the environment information may include external information received from an external device, such as situation information and operation information of traffic control facilities. The situation information is event information occurring on the path of the mobile object 100 and may include, for example, a traffic flow state, accident information, construction information, weather information, and the like. The operation information may include, for example, duration times, waiting times, and the like related to stopping, driving, and caution of traffic lights installed on the road. That is, the environment information is element information estimated to affect the movement control of the mobile object 100 and may be generated by at least one among the states of road static objects, states of road dynamic objects including moving trajectory, situation information, and operation information.

Meanwhile, the storage unit 118 may store and manage map information including path information and various information related to the driving path received from the servers 200-1, 200-2, 200-n, and 250. The map information may be used to generate a driving path set for the mobile object 100 in response to the request of the user or the control unit 120. In addition, the map information may be utilized for autonomous driving, and may include a low-definition map or a high-definition map together with the map. The map information may be prepared to have various information and data included in the objects and environments described above.

The control unit 120 may perform the overall control of the mobile object 100. The control unit 120 may be configured to execute applications and instructions stored in the storage unit 118. The control unit 120 may activate autonomous driving and control the mobile object 100 in response to an autonomous driving request of the user or by setting of the mobile object 100 itself. In addition, the control unit 120 may control to deactivate autonomous driving and drive the mobile object 100 manually in response to a request according to the user's release or automatic release.

In relation to the present disclosure, the control unit 120 may generate real-time environment information based on the recognition information and positioning information acquired from the sensor unit 102 of the mobile object 100 and the external information received from an external device, using the applications, instructions, and data stored in the storage unit 118. In addition, the control unit 120 may transmit the environment information, detailed information related to the mobile object 100, and user information related to the user of the mobile object 100, and receive optimal map information. Characteristic information may include at least one among the type of the mobile object 100, sensing performance of the mobile object 100, processing performance of the mobile object 100, and communication performance of the mobile object 100. The user information may include at least one among a preferred path and a path pattern on the route along which the mobile object 100 moves. The user information is not limited to those described above, and may also include options related to driving and a path selected by the user, and driving experiences and path experiences inferred by learning.

In addition to this, the control unit 120 may transmit mobility detailed information to the server 200. The mobility detailed information may be information that is referenced by the server 200 to adjust or refine detailed data and detailed settings of map information. The mobility detailed information may include, for example, sensor information including detailed specifications of the sensor unit 102 including the observation sensors 104a to 104c and the positioning sensor 104d and detailed performance of the sensor unit 102, and mobility constraint information according to the type and specifications of the mobile object 100. The sensor information may include, for example, detailed specifications of the observation sensors 104a to 104c and the positioning sensor 104d, observation ranges of the observation sensors 104a to 104c, detailed resolutions, calibration methods, types of sensors constituting the positioning sensor 104d, and fine precision of the positioning sensor 104d. The mobility constraint information may include, for example, profile information including environmental restrictions based on the type of the mobile object 100, i.e., ground, aerial, or maritime mobile object, and essential elements for map information.

In the present disclosure, the control unit 120 may be implemented, for example, as a single processing module, or as another example, the processing described above may be processed in a plurality of processing modules in a distributed manner.

Referring to FIG. 3, the local server 200 functions as an autonomous driving support device according to the present disclosure as described above, and may include a communication unit 202, a memory 204, and a processor 206.

The communication unit 202 may support mutual communication with the mobile object 100, the infrastructure support device 300, and the surrounding mobile objects 500. In the present disclosure, the communication unit 202 may receive data generated or stored during the driving of the mobile object 100 and the surrounding mobile objects 500, and transmit data and software modules to the mobile object 100 and the surrounding mobile objects 500. As shown in FIG. 1, the communication unit 202 may receive environment information from a plurality of mobile objects, i.e., the mobile object 100 and other mobile objects 500. In addition, optimal map information generated to match each mobile object 100 by the processor 206 based on the environment information may be transmitted to each mobile object 100 through the communication unit 202. In addition, real-time situation recognition, path updates, emergency commands, or the like generated by the processor 206 may be transmitted to a plurality of mobile objects 100 through the communication unit 202.

The memory 204 may store applications and various data for controlling the local server 200, and load applications or read and write data in response to the request of the processor 206. In the present disclosure, the memory 204 may store applications analyzed in combination with environment information transmitted from the mobile object 100, various data collected inside and outside the mobile object 100, and legal regulation information, and analyzed based on the context, to provide an optimal path.

Specifically, the memory 204 may store an application and at least one instruction for processing selection, adjustment, transmission, feedback, and update of the optimal path analyzed based on the context.

The processor 206 may perform the overall control of the local server 200. The processor 206 may be configured to execute applications and instructions stored in the memory 204.

In relation to the present disclosure, the processor 206 may select optimal path information analyzed in combination with various data collected inside and outside the mobile object 100 and legal regulation information using the applications, instructions, and data stored in the memory 204, and analyzed based on the context, and adjust the path information based on the preference information of the user. The processor 206 may adjust the path information in detail based on the user information and the mobility detailed information, transmit the adjusted path information to the mobile object 100, and update the map information according to the feedback information of the path information transmitted from the mobile object 100.

In the present disclosure, the processor 206 may be implemented, for example, as a single processing module, or as another example, the processing described above may be processed in a plurality of processing modules in a distributed manner.

In the present disclosure, a plurality of mobile objects 100 may generate and transmit real-time environment information, and the local server 200 may use learning based on the plurality of environment information to infer a context on the route along which the plurality of mobile objects 100 moves, and generate integrated environment information based on the inferred context. The context may be inferred to have moving trajectories of the plurality of mobile objects 100 and situational elements referenced for movement control through the trajectories of the plurality of mobile objects 100. In addition to the real-time environment information, the integrated environment information may include predicted environment information expected based on the inferred context. As another example, some of the plurality of mobile objects 100 may transmit the recognition information, observation information, and recognized situation information to the server 200, and the local server 200 may generate integrated environment information based on the information.

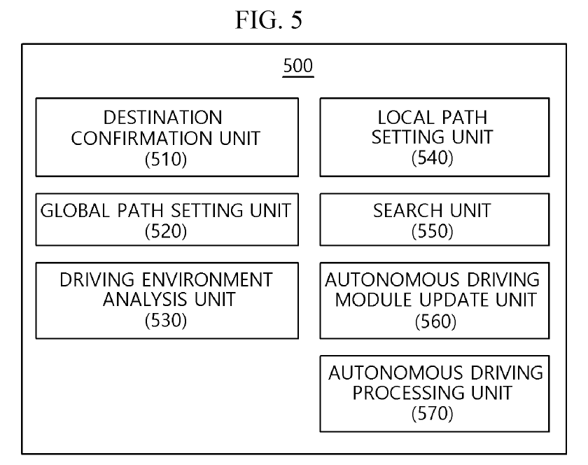

Referring to FIG. 4, the central server 250 functions as an autonomous driving support device according to the present disclosure as described above, and may include a communication unit 252, a memory 254, and a processor 256.

The communication unit 252 may support mutual communication with the local server 200 and the like. In the present disclosure, the communication unit 252 may perform data synchronization with the local server 200. That is, the communication unit 252 may transmit data and software modules needed for the mobile object 100 and surrounding mobile objects 500 to the local server 200, and receive information collected from a plurality of mobile objects, i.e., the mobile object 100 and other mobile objects 500, from the local server 200.

The memory 254 may store applications and various data for controlling the central server 250, and load applications or read and write data in response to the request of the processor 256. In the present disclosure, the memory 254 may store applications analyzed in combination with environment information transmitted from the mobile object 100, various data collected inside and outside the mobile object 100, and legal regulation information, and analyzed based on the context, to provide an optimal path.

Specifically, the memory 254 may store an application and at least one instruction for processing selection, adjustment, transmission, feedback, and update of the optimal path analyzed based on the context.

The processor 256 may perform the overall control of the central server 250. The processor 256 may be configured to execute applications and instructions stored in the memory 254.

In relation to the present disclosure, the processor 256 may select optimal path information analyzed in combination with various data collected inside and outside the mobile object 100 and legal regulation information using the applications, instructions, and data stored in the memory 254, and analyzed based on the context, and adjust the path information based on the preference information of the user. The processor 256 may adjust the path information in detail based on the user information and the mobility detailed information, transmit the adjusted path information to the mobile object 100, and update the path information according to the feedback information of the path information transmitted from the mobile object 100.

In the present disclosure, the processor 256 may be implemented, for example, as a single processing module, or as another example, the processing described above may be processed in a plurality of processing modules in a distributed manner.

Hereinafter, the configuration and operation of an autonomous driving software module (hereinafter, referred to as an “autonomous driving module”) according to an embodiment of the present disclosure will be described. The autonomous driving module may be installed in the memory provided in the mobile object 100 and executed by the processor provided in the mobile object 100. In addition, the autonomous driving module may be stored in the central server 250 and the local server 200, and the autonomous driving module stored in the central server 250 or the local server 200 may be trained using information collected from the mobile object 100. In addition, the autonomous driving module trained by the central server 250 or the local server 200 may be provided to the mobile object 100 so that an update may be performed on the autonomous driving module included in the mobile object 100.

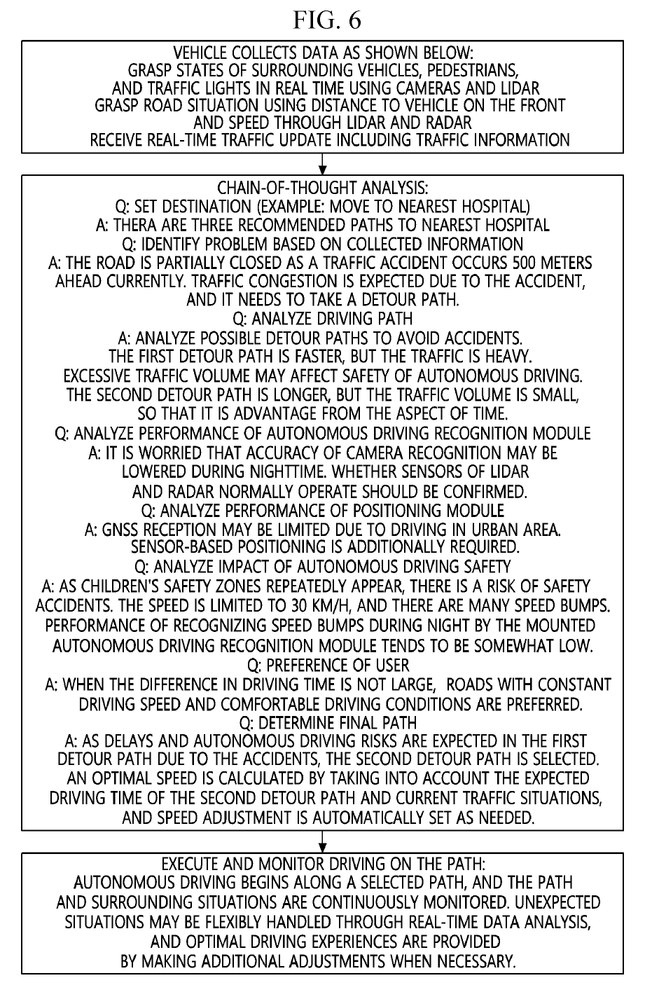

First, FIG. 5 is a block diagram showing the configuration of an autonomous driving module according to an embodiment of the present disclosure.

Referring to FIG. 5, the autonomous driving module 500 includes a destination confirmation unit 510, a global path setting unit 520, a driving environment analysis unit 530, a local path setting unit 540, a search unit 550, an autonomous driving module update unit 560, and an autonomous driving processing unit 570.

The destination confirmation unit 510 may confirm information on the starting point, waypoints, and destination of the autonomous driving system (hereinafter referred to as “destination information”). The destination information confirmed by the destination confirmation unit 510 may be provided to the global path setting unit 520, and the global path setting unit 520 may use the destination information to set a global path for autonomous driving of the mobile object 100. Here, the global path is a path continued from the starting point to the destination, and may include a path typically set for navigation of the mobile object. In particular, the global path set by the global path setting unit 520 may be a path set by reflecting the movement pattern, preference, or like of the user.

Meanwhile, the global path set by the global path setting unit 520 may be provided to the driving environment analysis unit 530, and the driving environment analysis unit 530 may confirm the driving environment information of the global path, and evaluate performance of autonomous driving on the global path based on the driving environment information. When performance of autonomous driving on the global path exceeds a predetermined reference as a result of the performance evaluation, the driving environment analysis unit 530 may request the local path setting unit 540 to set a local path. Accordingly, the local path setting unit 540 may set a local path for autonomous driving in lane units using the driving environment information. Herein, the local path setting unit 540 may check the autonomous driving performance information of the mobile object, and set the local path by reflecting the autonomous driving performance information

Furthermore, when the evaluated performance of autonomous driving is lower than a predetermined reference, the driving environment analysis unit 530 may request an autonomous driving module suitable for the global path from the search unit 550, and the search unit 550 may receive an autonomous driving module suitable for the global path from the central server 250 or the local server 200. Then, the search unit 550 may provide the received autonomous driving module suitable for the global path to the autonomous driving module update unit 560, and the autonomous driving module update unit 560 may update the autonomous driving module suitable for the global path. Thereafter, the local path setting unit 540 may set a local path for autonomous driving in lane units using the updated autonomous driving module.

Furthermore, the driving environment analysis unit 530 may evaluate performance of autonomous driving on the local path, and when performance of autonomous driving on the local path exceeds a predetermined reference as a result of the evaluation, autonomous driving based on the global path and the local path may be performed through the autonomous driving processing unit 570.

Meanwhile, when performance of autonomous driving on the local path is lower than a predetermined reference as a result of the evaluation, the driving environment analysis unit 530 may call the global path setting unit 520 to perform again the operation of setting a global path described above.

Hereinafter, each operation processed by the destination confirmation unit 510, the global path setting unit 520, the driving environment analysis unit 530, the local path setting unit 540, the search unit 550, the autonomous driving module update unit 560, and the autonomous driving processing unit 570 will be described in detail.

The destination confirmation unit 510 may confirm destination information for performing autonomous driving. Specifically, the destination confirmation unit 510 may provide an environment (User Interface, UI) for receiving information on the starting point, waypoints, and destination, and the like for performing autonomous driving, and confirm information on the starting point, waypoints, and destination input through the environment (UI) that can receive information on the starting point, waypoints, and destination. For example, a text input window or a voice recognition interface may be provided in the mobile object 100 or a device (e.g., a portable terminal, a personal computer, a laptop, or the like) of a user using the mobile object 100, and information on the starting point, waypoints, and destination may be input through the text input window or the voice recognition interface. Specifically, through a touch screen embedded in the dashboard of the mobile object 100, a text input window for a user to input text may be provided, and information input into the text input window may be confirmed. At this point, the text input window may be configured as an intuitive graphical user interface (GUI). A button (e.g., a physical button or a touch button provided on a media device of the mobile object 100) for initiating voice recognition may be provided in the mobile object 100, and a voice recognition module for analyzing voice that is input after the button initiating voice recognition is operated using a natural language processing (NLP) technique may be included.

As another example, as a module for performing the destination confirmation unit 510 is executed in the device (e.g., a portable terminal, a personal computer, a laptop, or the like) of a user using the mobile object 100, a text input window in which the user may input text is provided and information input into the text input window is confirmed, or information on the starting point, waypoints, and destination input by the user may be confirmed through an application or a web interface that provides map information to the device of the user using the mobile object 100.

As another example, the destination confirmation unit 510 may learn frequently visited waypoints, destinations, and the like of the user by confirming the account of the user and analyzing the driving history and preferences of the user. For example, a function of automatically setting a commuting path every Monday morning may be provided. As another example, the destination confirmation unit 510 may provide a list of recommended waypoints, destinations, and the like considering the current location, time, traffic situations, and the like, and confirm waypoints, a destination, and the like selected by the user from the provided list. For example, a nearby restaurant may be recommended at lunch time, an alternative path for avoiding traffic congestion may be suggested, or a gas station or an electric vehicle charging station on the path may be suggested when refueling is required.

The global path setting unit 520 may recommend and set a global path based on the starting point, waypoints, destination, and the like confirmed through the destination confirmation unit 510. At this point, the recommended global path may be a path most preferred by the user or a path advantageous for autonomous driving.

In addition, when recommending a global path, the global path setting unit 520 may use map information, real-time traffic information, road state information, geographical elements, environment information, vehicle information, legal regulation information, and the like. The map information, real-time traffic information, road state information, geographical elements, environment information, vehicle information, legal regulation information, and the like may be acquired from the infrastructure support device 300 or acquired through sensors or the like provided in the mobile object.

The map information may include information on the road network, vehicle position, number of lanes, intersection structure, locations and properties of traffic lights, information on the frequency and reliability of map update, information on tolls, or the like. The real-time traffic information may include information on traffic congestion, occurrence of traffic accidents, occurrence of road construction or maintenance works, or the like. The road state information may include information on the type of road (information indicating tunnels, bridges, general roads, expressways, unpaved roads, or the like), information on the road surface conditions such as frozen or wet road surfaces, and information on road pavement conditions such as potholes or wear of road surfaces. The geographical elements may include information indicating topographical characteristics such as mountains, flat lands, and slopes, information indicating urban areas or residential areas, information indicating areas requiring protection of vulnerable road users, and information indicating tourist attractions and points of interest around the destination. The environment information may include information indicating weather conditions such as rain, snow, and fog, information indicating time such as day, night, and dawn, information indicating characteristics of light such as backlight, and information indicating seasonal or weather changes. The vehicle information may include the vehicle size and weight, fuel level, whether charging is needed, performance and detection range of vehicle sensors, processing speed and response time, and the like. The regulation information may include information on no traffic zones, information on traffic restrictions specific to vehicle types, information on traffic restrictions specific to time, information on speed limits, and the like.

In order to perform recommendation of a global path, the global path setting unit 520 may include a global path learning model. The global path learning model may perform learning of the movement pattern, preference, and or like of the user based on the driving data and location information of the user. For example, the global path setting unit 520 may continuously collect driving data and location information of the user and use them as an input of the global path learning model, and may collect information on the movement pattern and preference of the user for each pattern and use them as an output of the global path learning model.

Here, the driving data of the user used as an input may include a global path including visited locations, driving time, starting point, waypoints, destination, and the like. In addition, the movement pattern of the user used as an output may include the shortest distance, shortest time, use of toll-free roads, avoidance of traffic congestion, and the like. In addition, information on the preference for each pattern may include information that numerically quantifies the preference for each pattern into a value of a predetermined range (e.g., 1 to 10) or information on the preference for each pattern that is set to a predetermined level (e.g., highest level, upper level, middle level, lower level, lowest level, or the like).

Although the movement pattern of the user is exemplified as the shortest distance, shortest time, use of toll-free roads, avoidance of traffic congestion, or the like in the embodiments of the present disclosure, the present disclosure is not limited thereto and may be changed and applied in various ways.

Based on the above descriptions, the global path setting unit 520 may input information on the starting point, waypoints, destination, and the like into the previously trained global path learning model, and confirm the movement pattern, preference, or the like of the user output through the previously trained global path learning model. In addition, the global path setting unit 520 may set and provide a global path that matches the movement pattern, preference, or the like of the user. For example, the global path learning model may output a plurality of movement patterns of the user and information on the preference for each pattern, and the global path setting unit 520 may select at least one among the plurality of movement patterns of the user and set a global path based on the information on the preference. Specifically, the global path setting unit 520 may select a movement pattern with the highest preference value among the plurality of movement patterns of the user, e.g., a traffic congestion avoidance pattern, and the global path setting unit 520 may sort the global paths in order of low congestion according to the movement pattern of the user, and set a global path with the lowest congestion among the sorted global paths to be provided preferentially.

As another example, the global path setting unit 520 may select a plurality of movement patterns of the user and set a global path by combining the plurality of movement patterns of the user. For example, the global path setting unit 520 may select movement patterns of the user having a value greater than a predetermined threshold among the plurality of movement patterns of the user and provide a global path set in accordance with a combination of the selected movement patterns of the user. Furthermore, the global path setting unit 520 may specify requirements for information on the movement pattern and preference of the user for each pattern through a language model based on a natural language. Such requirements may be analyzed in combination and with various data collected inside and outside the vehicle and legal regulation information, and analyzed based on the context to determine an optimal path.

The input preference is reflected in the process of determining a global path in real time. The system dynamically adjusts and optimizes the global path according to the preference. At this point, the command and preference input by the user are in the form of natural language, and their context may be analyzed and applied together with the global path and related information.

Additionally, documents such as user commands, legal regulations, surrounding environment information, and tourist guidelines, and Points Of Interest (POI) on the map platforms may be utilized for analysis of contextual information.

Although it is described as an example that the global path setting unit 520 sets a global path based on the user preference, the present disclosure is not limited thereto, and may be changed and used in various ways. As another example, the global path setting unit 520 may set a global path that is advantageous for autonomous driving. For example, the global path setting unit 520 may set a path with a road surface on which the sensors may operate more effectively, a path that requires fewer lane changes, or the like as a global path to maximize performance of sensors and software of the autonomous vehicle. Specifically, since the mobile object 100 may recognize surrounding environments using various sensors (e.g., LiDAR, camera, radar, positioning sensor), the global path setting unit 520 may select a path on which various sensors (e.g., LiDAR, camera, radar, positioning sensor) may exhibit optimal performance. That is, the global path setting unit 520 may preferentially select a path on which the mobile object 100 may drive within the detection range of the sensors considering the characteristics of each sensor, and confirm driving safety of the mobile object 100 using map information, real-time traffic information, and the like. In addition, the global path setting unit 520 may adjust the global path by exchanging dynamic environment information of the surroundings in real time through a multidimensional communication network by integrating V2X (vehicle-to-infrastructure), V2V (vehicle-to-vehicle), and V2P (vehicle-to-pedestrian) communications. In addition, the global path setting unit 520 may monitor changes in the performance of the vehicle sensors in real time according to the environment information, and set a global path optimized for the changes in the performance. In addition, the global path setting unit 520 may set a global path by optimizing energy efficiency considering geographical elements.

The global path setting unit 520 may convert information recognized from the sensor unit 102 of the mobile object 100 in the form of a natural language, and analyze together with map information, traffic situation information, traffic facility information, and predicted movements of surrounding objects. For example, the global path setting unit 520 may analyze information on the behavior patterns of objects, weather, and traffic light states extracted from image information, in combination with location and attribute information on a high-definition map. In addition, as another example, the global path setting unit 520 may analyze information on the state of traffic lights received through a communication network (V2X (vehicle-to-infrastructure), V2V (vehicle-to-vehicle), V2P (vehicle-to-pedestrian) communication, or the like), and configure a next behavior in the form of a natural language, a driving trajectory, or the like, and perform planning and control of autonomous driving of the mobile object 100. Specifically, the global path setting unit 520 may test and optimize the response of a vehicle by virtualizing various driving scenarios in expressing the next behavior. Through this, strategies for responding to various situations may be confirmed, and overall driving strategies of the autonomous driving system may be precisely controlled. Furthermore, in virtualizing various driving scenarios, the global path setting unit 520 may convert driving constraints, such as existing laws, regulations, and guidelines, user information such as tourist site information and surrounding point of interest (POI) information, and driving situation information recognized by the sensors, in a natural language, estimate driving scenarios that may occur within the driving path through a language model, and set a response strategy.

In addition, in setting a global path, the global path setting unit 520 may set global paths with guaranteed emergency paths and response methods in preparation for an emergency situation. For example, the global path setting unit 520 may set a driving path or pattern that allows the vehicle to immediately change the path or take needed countermeasures through rapid communication with the central server 250 in the event of an accident or an unexpected situation. Furthermore, for an appropriate response of the autonomous driving system in an emergency situation, the global path setting unit 520 may analyze documents of legal regulations and emergency response guidelines and information within the vehicle and server in the form of natural language to grasp the context and take countermeasures.

In addition, the global path setting unit 520 may search for an autonomous driving module and data required to perform the autonomous driving module by analyzing similarity of related words, context, images, geometry, and space information with previously input data, based on expected traffic situations, driving environments, vehicle conditions, and the like that can be extracted according to driving scenarios needed on the set global path.

In addition, the global path setting unit 520 may virtualize an autonomous driving situation based on the path on the navigation and the autonomous driving control plan related thereto, a result of recognizing surrounding environments, weather, road situations, traffic situations, road facilities, communication environments, laws and regulations, and vehicle conditions, confirm data deficient in the autonomous driving and performance of the autonomous driving module, and improve the autonomous driving module and data required to perform the autonomous driving module.

The driving environment analysis unit 530 may analyze and predict surrounding environments and expected traffic situations by utilizing contextual information of autonomous driving information connected to the global path. At this point, the driving environment analysis unit 530 provides an analysis optimized for the situation by referring to real-time data and an existing database. In order to collect real-time data, the driving environment analysis unit 530 may confirm information on the surrounding environment based on the data collected through the sensor unit of the mobile object 100. Information on the surrounding environment may include information on other vehicles, information on pedestrians, information on road obstacles, and the like. At this point, multidimensional data may be collected through the sensor unit of the mobile object 100, and the multidimensional data may be collected to be associated through operations such as data synchronization, sensor fusion, georeferencing, and the like.

In addition, the multidimensional data may include external source data including data on road congestion, accident occurrence information, and the like provided by an ITS, weather data provided by a weather information system, and the like, HDMap including exact location of lanes, traffic lights, road signs, intersection configurations, and the like, driving data including prior information such as high-definition maps, nodes or links connecting the nodes, or polygons indicating roads or lane areas, and the like.

The multidimensional data generated in this way may be converted through a kernel such as convolution, and fused and analyzed together with the driving trajectory, and may be used to predict and analyze movements of mobile objects or to make a local path plan. In addition, multidimensional raster data may be converted into data of a vector form of multi-layer, and the converted data of mutual layers may be connected and analyzed as a topological relation is defined.

The multi-layer data described above may have connectivity together with the driving trajectory, and static, semi-static, and semi-dynamic data on the map data may be connected to dynamic driving trajectory data and analyzed as input data.

The driving environment analysis unit 530 may identify the multi-layer data including static, semi-static, dynamic, and semi-dynamic data, and determine the appropriate an optimal path setting module corresponding to the confirmed multi-layer data. When there is no appropriate optimal path setting module that operates on the existing driving design in correspondence to the multi-layer data described above, the driving environment analysis unit 530 may request the local server 200 or the central server 250 to modify the previously stored optimal path setting module by reflecting the multi-layer data described above, data registered on the server, and newly virtualized data, and may receive the modified optimal path setting module from the local server 200 or the central server 250. Accordingly, the driving environment analysis unit 530 may apply the updated optimal path setting module to be utilized for autonomous driving.

Furthermore, in analyzing data collected from the mobile object 100 in the form of natural language, the driving environment analysis unit 530 may extract advanced contextual information by converting data collected from a camera, LiDAR, radar, and the like into a text through a vision-language model, or converting numerical data into a text through an object detection and tracking model and algorithm, and fusing the data. In addition, in extracting the contextual information, the driving environment analysis unit 530 may define a chain-of-thought analysis driving scenario, which connects problems to be solved in an autonomous driving operation with related information, and perform a path plan. At this point, the texts may be expressed in various languages and translated into each other. For example, contents such as area names, attribute information, or the like indicated on the road surfaces or signboards may be converted into terms (or formats) that the user or the autonomous driving system may interpret.

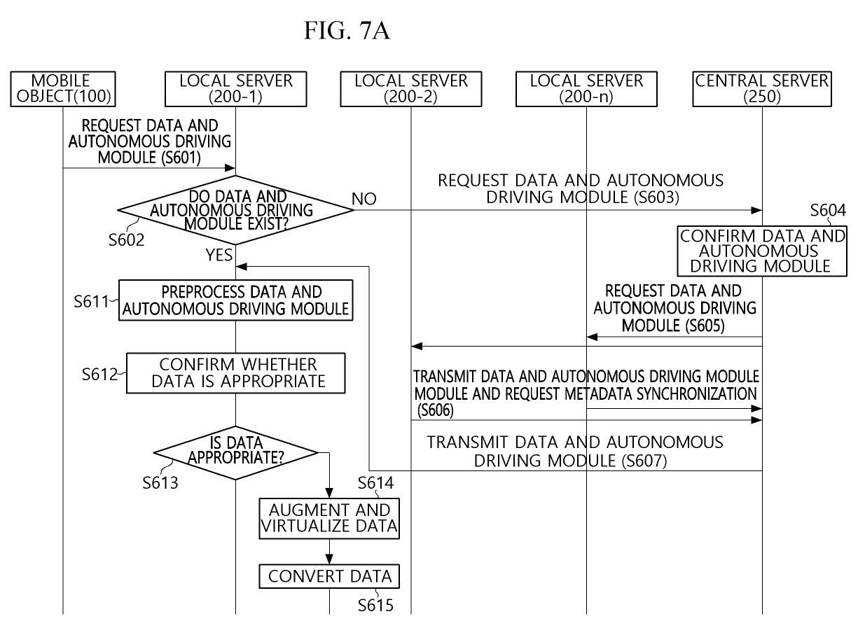

Furthermore, the driving environment analysis unit 530 may include a chain-of-thought analysis model for defining a chain-of-thought analysis driving scenario and performing a path plan. For example, the chain-of-thought analysis model may perform a chain-of-thought based on a driving scenario (e.g., see FIG. 6) using data collected from cameras, LiDAR, radar, and the like and converted into a text as an input, and output a path plan based on the data.

In addition, the driving environment analysis unit 530 may include a language model, and the language model may analyze information such as traffic reports, accident updates, and changes in road condition provided in real time in the form of natural language. This information may obtain important insights from text data, and the contents may be integrated into the decision-making process of the vehicle to immediately adjust the path. In addition, as the language model may enables natural language-based interactions with the driver within the mobile object 100, allowing easy path adjustments or settings may be processed through voice commands.

Furthermore, the driving environment analysis unit 530 suggests the most appropriate path for the vehicle and adjusts the path as needed, by identifying high-risk sections through analysis information and predicting expected traffic situations through traffic flow analysis.

The local path setting unit (Local Path Planning Section) 540 sets a local path for autonomous driving of lane units based on the global path set by the global path setting unit 520 and the driving environment information analyzed by the driving environment analysis unit 530.

The local path setting unit 540 may set a local path by performing operations of data integration, path planning, and path determination. Additionally, the local path setting unit 540 may set the local path based on the autonomous driving performance information.

First, to perform the data integration operation, the local path setting unit 540 may set a local path by integrating real-time traffic data, environmental conditions, map information, and information affecting the local context through the driving environment analysis unit 530. This data may include traffic congestion levels, road construction updates, weather conditions, V2X information, and the like. Furthermore, since the autonomous driving performance may be set differently for each mobile object, the local path setting unit 540 may check the autonomous driving performance information indicating the autonomous driving performance, and set the local path.

In addition, the local path setting unit 540 may include a local path planning model for performing a local path planning operation, and the local path planning model may receive the integrated data, and generate candidate local paths. In addition, the local path planning model may receive information on real-time events such as road closures, traffic congestion, and accidents, and dynamically adjust and output a local path corresponding thereto.

In addition, the local path setting unit 540 may include a local path planning model for performing local path determination, and the local path planning model may determine and output a final local path using contextual information combined with contextual and real-time driving situation information.

The local path planning model may be trained through Dynamic Window Approach (DWA), Rapidly-exploring Random Tree (RRT), Model Predictive Control (MPC), A* Algorithm, Voronoi Diagrams, Visibility Graph, Artificial Potential Fields, Hybrid A* Algorithm, reinforcement learning, or the like. Here, the Dynamic Window Approach (DWA) may be a model configured to calculate a set of attainable speeds considering the current speed and acceleration limit of a robot, and select a speed that maximizes an objective function. Using the DWA, road safety and operational efficiency may be maximized through an ability of efficiently responding by adapting to immediate obstacle avoidance and real-time traffic situations. The rapidly-exploring Random Tree (RRT) may be a model configured to randomly construct a space-filling tree while rapidly exploring the space. The RRT is designed to quickly adapt to complex environmental changes, and may effectively search for a path even in an unexpected situation such as road closure or construction. The Model Predictive Control (MPC) may be a model configured to predict and optimize the driving path over a time range of future using a vehicle dynamics model. The MPC may achieve stability and efficiency at the same time by considering various constraints and goals, and may make more precise driving decisions by including variables such as weather conditions and road states. The A* Algorithm may be a model configured to search for a minimum cost path considering traffic states. The A* Algorithm may calculate traffic flows and expected delays in real time to avoid congestion and find an efficient path, and provide an optimal path. The Voronoi Diagrams may be a model configured to dynamically generate a safe path in a road network considering surrounding environments. The Voronoi Diagrams may provide an optimal path while maintaining a safe distance in a rapidly changing situation such as urban traffic. The Visibility Graph may be a model configured to adjust the line of sight by analyzing, in real time, environmental data collected from cameras and LiDAR. Through the Visibility Graph, the mobile object 100 may effectively avoid unexpected obstacles and maintain safe driving. The Artificial Potential Fields method may be a model configured to dynamically adjust the path by generating virtual attractive and repulsive forces between obstacles and targets. The Artificial Potential Fields method allows the mobile object 100 to naturally avoid obstacles and effectively move to a target point. The Hybrid A* Algorithm method may be a model configured to effectively plan a path even in a more complex road environment by combining the A* Algorithm and a heuristic-based approach. In particular, the Hybrid A* Algorithm method is configured to determine an optimal path in real time considering areas with traffic regulations and various driving environments. The Hybrid A* Algorithm method improves path planning by including complex maneuver plans (no traffic zones, one-way streets, and driving regulations in a specific area) and real-time situation data. The reinforcement learning may be a model configured to allow an agent to interact with a given environment and learn in a direction maximizing rewards from the results of behaviors. In a mobile object that performs autonomous driving, the agent is the mobile object itself, and the environment includes the road on which the mobile object is driving and its surrounding conditions. The reward function plays an important role for inducing safe and efficient driving. The reinforcement learning utilizes contextual information to adjust the path by avoiding traffic congestion and quickly responding to an unexpected situation.

The local path setting unit 540 may dynamically select and apply an algorithm to effectively respond to dynamically changing roads and traffic situations. As the algorithm may work better for specific environmental factors, the local path setting unit 540 may select and apply the most suitable algorithm in real time. The characteristics of each algorithm may be expressed in a natural language, and may be determined by setting each situation as an input value and a corresponding algorithm and parameters as output values. For example, the local path setting unit 540 may utilize Modal Predictive Control (MPC) in an environment that requires a quick response in a heavy traffic city center, and may select A* or RRT, which are advantageous for optimization of a long-distance path in an open highway environment.

The local path setting unit 540 may determine an algorithm by analyzing sensor data of the vehicle and real-time traffic information. For example, in an environment where the vehicle is approaching a traffic congestion area, the local path setting unit 540 may activate the MPC algorithm based on real-time traffic data to recalculate the path. In addition, in an environment where traffic congestion or accidents can be avoided using the DWA in an environment where an unexpected events occurs, the local path setting unit 540 may perform path change. In this way, the local path setting unit 540 may adaptively determine an algorithm based on positioning data, real-time traffic updates, and contextual information collected from cameras and sensors.

Furthermore, the local path setting unit 540 may generate various paths through the various algorithms or learning models described above, evaluate each of the generated paths, and determine at least one algorithm or learning model based on the evaluated result. At this point, the local path setting unit 540 may perform the evaluation based on criteria such as safety, efficiency, traffic laws, legal compliance, and the like. For example, the local path setting unit 540 may determine an algorithm or learning model so that a path that maximizes safety and legal compliance while minimizing driving time and energy consumption may be set.

Furthermore, the local path setting unit 540 may be configured to determine an algorithm or learning model using performance of the vehicle and feedback from environmental interactions to improve accuracy and reliability over time. For example, driving data in a weather condition such as rain or snow may be configured to adjust the algorithm or learning model so that the vehicle may exhibit further better performance under similar conditions in the future.

In addition, in a continuous learning and update process, more accurate and reliable learning results may be generated by utilizing the contextual information. Data collected while the vehicle is driving under various weather conditions may be used to improve the response model of the vehicle, and for example, driving data on a slippery road may be used to adjust the model predictive control (MPC) algorithm to improve handling and stability of the vehicle under similar conditions in the future. This contextual learning allows the vehicle to perform control efficiently in more complex and diverse road environments.

The search unit 550 may request and receive an autonomous driving module and data required to perform the autonomous driving module from the local server 200 or the central server 250 so that data processing of the mobile object 100 moving autonomously and resources for performing the autonomous driving module may be optimized. The autonomous driving module may include a plurality of sub-modules. For example, as shown in FIG. 6, the autonomous driving module may include, as sub-modules, a data collection module, a recognition module, a position confirmation module, a prediction module, a motion planning module, a language model module, a context prediction module, a data analysis module, a mapping module, and a path prediction module. Based on this, the search unit 550 may request and receive sub-modules and data required to perform the sub-modules from the local server 200 or the central server 250 so that the resources for performing the autonomous driving module of the autonomous mobile object 100 may be optimized.

The search unit 550 may search for accurate road and traffic data in real time by utilizing V2X communication and map information, and collect data by integrating various sensor data and external information sources. The collected data is structured and managed through metadata, and the metadata is important for quickly identifying and mapping characteristics of data.

Data collected from various sensors such as cameras, LiDAR, and radars may be processed for georeferencing through synchronization and fusion of data between sensors and combination with positioning information. Each sensor data may be fused through internal and external parameters, and this may be used to analyze the distance or observation angle with respect to an object in a three-dimensional coordinate system.

For example, object information recognized by the camera may be processed as precise 3D location information in association with LiDAR data. In addition, fusion of camera data and LiDAR data may be adjusted in the position and posture using rigid body transformation, similarity transformation, or camera geometric transformation models. Data integration like this may organize information that changes according to various traffic situations such as traffic lights, crosswalks, and intersection information, and provide the organized information as an important input for making a plan, determination, and control of autonomous vehicles. In addition, sensor data and object information assigned with an exact location may be integrated with high-definition map information and provided as detailed information on the target object. In this process, messages received through a multidimensional communication such as V2X, V2V, or V2P may include information related to traffic lights, crosswalks, intersections, and the like, and this information may be combined and configured in the format of metadata according to changing situations such as time, weather, and traffic congestion. For example, traffic light information reflects a lighting state that changes over time and may be used as criteria for planning, determining, and controlling driving paths and autonomous driving. In addition, the traffic light may include specific information such as ignition of green or red light. Data in a specific time zone may be stored as metadata by tracking and analyzing the changes. The metadata may include information on the same region and time zones, such as traffic congestion, road construction, lane changes of surrounding dynamic objects, movement of pedestrians on crosswalks, and the like, and may be used as prior information for a planning and decision-making algorithm of an autonomous vehicle.

The metadata described above allows autonomous vehicles to quickly search for data or autonomous driving modules (or sub-modules) that they need. For example, when a vehicle needs to respond to a specific road situation, it may immediately inquire and utilize necessary traffic state information or road condition data through relevant metadata.

As described above, although data should be managed as metadata to be advantageous for data search, collected original data may not include information on the metadata that can explain the data. Therefore, the search unit 550 may include a metadata recording model as a machine learning model that can record metadata in the original data. For example, the metadata recording model may be configured to generate and store metadata corresponding to the original data. For example, the metadata recording model may extract data of a natural language form by inputting collected original data into a language model or a vision-language model, and store the extracted data of a natural language form by mapping metadata corresponding to the data. Here, the language model may analyze various forms of natural language data (social media updates, traffic reports, emergency notifications) to identify and analyze keywords and contexts important for the vehicle. For example, tweets or traffic reports including the expression "traffic congestion" may be analyzed to grasp an expected traffic volume and delay time based on the information. The extracted information is contextually analyzed in combination with the location, expected path, and surrounding environment information of the vehicle, and through this, the vehicle adjusts a customized path corresponding to the surrounding situation and dynamically changes the driving strategy. Based on various metadata such as user information, vehicle information, map information, location, path, time, weather, legal regulations, and the like accumulated through this, the search engine may define an autonomous driving scenario and search for optimal data.

The language model automates generation and management of metadata through sophisticated metadata indexing and minimizes data search time. Through this, computing resources of the vehicle may be used efficiently, and required data and autonomous driving modules (or sub-modules) may be rapidly searched and applied.

Furthermore, as the search unit 550 understands complex queries by utilizing the language model and quickly maps related metadata, accuracy of search results may be guaranteed, and fast search performance may be provided even in a large-scale data environment through parallel and distributed processing.

For example, when there is road closure information, the search unit 550 may quickly suggest an alternative path excluding the road through keywords such as ‘closure, traffic congestion, traffic accident’. The keywords are extracted from various data sources such as traffic management systems, public safety databases, social media feeds, and the like. In this way, data is processed through a context-aware filter. This filter analyzes semantic and contextual information from text data using a natural language processing technique, and extracts and uses only relevant information to determine a path considering the current location and destination of the vehicle.

The search unit 550 utilizes data accumulated in advance and metadata including key words, context, driving situation, location information, geographical context, and the like used in the autonomous driving module (or sub-module). This algorithm recognizes that different systems may express the same phenomenon differently, and searches for necessary data and autonomous driving modules (or sub-modules) by analyzing similarity of words and context. When there are words or sentences not defined in the metadata, information can be found by searching for similar words.

In registering and utilizing data accumulated in advance and key words, contexts, and the like that can express the autonomous driving module (or sub-module) in metadata in the search algorithm performed by the search unit (550), the method of expressing the same phenomenon may vary in each system, and metadata is searched for analyzing similarity of words and contexts, driving situations, location information, geographical contexts, and the like. In metadata search, there are cases where the same word or sentence is not defined as metadata. In such cases, similar words and sentences are used to derive optimal search results based on similarity.

Furthermore, the search unit 550 may perform the search using the following search algorithms.

The Cosine Similarity algorithm may search for the most relevant document by measuring similarity between text data. The Cosine Similarity algorithm calculates importance of each word based on the vector space model and is used to grasp contextual similarity. When similarity evaluation for a given situation is required, the autonomous driving system dynamically adjusts cosine similarity parameters to reflect the changed context, such as road states, traffic information, and the like. For example, when an emergency situation or a specific event occurs, a faster and more accurate response may be provided by adjusting the weight value of related information.

The Term Frequency-Inverse Document Frequency (TF-IDF) algorithm may calculate the weights of a word considering the frequency of each word and how rare the word is. This is essential for identifying core keywords of a document and searching for related documents. In a dynamic environment such as a traffic situation, the TF-IDF may dynamically adjust the weights by identifying keywords that are more important at a specific time zone or location. Through this, autonomous vehicles may extract information most relevant to the latest road situation and optimize the driving plan.

The clustering algorithm generates data sets having similar characteristics by naturally grouping data. Through this process, related data may be searched for more efficiently. When processing data that changes in real time, the clustering algorithm dynamically adjusts the number of clusters or selects a clustering algorithm so that data may be automatically classified into similar groups. For example, real-time response algorithms are improved by appropriately adjusting the clusters based on traffic patterns or accident data.

The Random Forest algorithm is an ensemble learning method that constructs a number of decision trees and derives the most effective prediction. This enables optimal search results by considering various characteristics of metadata. Whenever the environment changes, the Random Forest adjusts the number or depth of decision trees for better reflection of the characteristics of data. This is useful for predicting an optimal path according to, for example, traffic states or characteristics of drivable roads.

The Latent Dirichlet Allocation (LDA) algorithm may grasp topics of each document by modeling the topics in a document set , enabling topic-based searches and allowing retrieval of contextually similar documents. Topic modeling is used to identify topics related to changing road situations, and when a new event or information is input into the system, the LDA readjusts main topics by dynamically updating the model. This is especially important in providing appropriate response information in an emergency situation.

The Neural Language Models may be configured to learn complex patterns of language by utilizing deep learning, and extract deeper meaning and relations from text data based on this. Models such as GPT and BERT may be used to understand particularly the context of text. Deep neural network models continuously learn and adaptively detect linguistic changes occurring in an environment. For example, autonomous vehicles may learn terms frequently used in a specific area or new traffic patterns, and modify the driving situation prediction and response mechanism based on this.

Although search algorithms are exemplified in the embodiments of the present disclosure, the present disclosure is not limited thereto, and various search algorithms may be used. In addition, the search algorithms described above may be used alone, or two or more algorithms may be used in combination. For example, the Random Forest and the Neural Network Model are combined to understand and predict complex sensor/communication/infrastructure data and linguistic contexts so that decision-making optimized for a driving situation may be supported. Through this, predictability and adaptability to a driving situation are maximized through an artificial intelligence model in the real-time data analysis and decision-making process. For example, an optimal path may be dynamically determined in response to a real-time traffic situation, weather change, emergency situation, or the like, and potential risks may be prevented in advance.

The search algorithm as described above may support efficient data management and search in a distributed server environment including a local server 200 and a central server 250. In the distributed server environment including a local server 200 and a central server 250, necessary information may be efficiently queried and searched through multi-server search from the data stored in a distributed manner.

The autonomous driving module update unit 560 may perform update of the autonomous driving module by reflecting a sub-module searched through the search unit 550 to the autonomous driving module. At this point, the autonomous driving module update unit 560 may perform the update using the Firmware Over-The-Air (FOTA) protocol and may use an encryption protocol that maintains security during data transmission. The autonomous driving module update unit 560 may automatically perform the update for the autonomous driving module without intervention of a user and may provide an interface that allows the vehicle owner to monitor and adjust the update progress situation as needed.

The autonomous driving module update unit 560 may perform updates on the autonomous driving module in real time through the central processing unit of the vehicle. The autonomous driving module update unit 560 may be designed to make an update even when the vehicle is driving.

As described above, the search unit 550 may request an autonomous driving module (or sub-module) suitable for a global path from the central server 250 or the local server 200, and the central server 250 or the local server 200 may provide an autonomous driving module (or sub-module) suitable for the requested global path. Hereinafter, the operation of providing an autonomous driving module (or sub-module) by the central server 250 and the local server 200 will be described in detail.

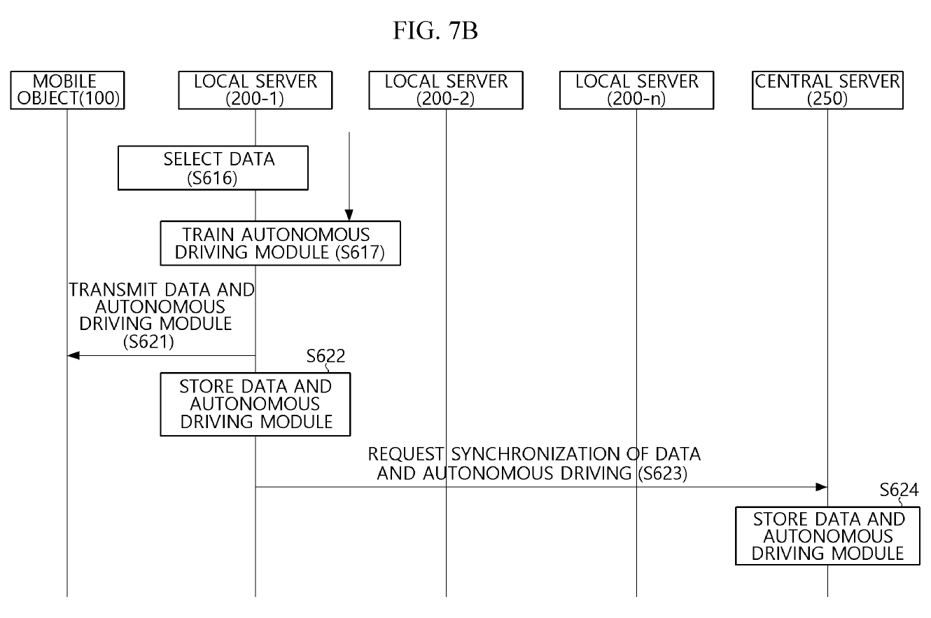

FIGS. 7A and 7B are flowcharts illustrating the operation of a central server and a local server in providing the autonomous driving modules in an autonomous driving system according to an embodiment of the present disclosure.

Referring to FIGS. 7A and 7B, the autonomous driving module providing operation may include a search operation (S601 to S607), a development operation (S611 to S617), and a distribution operation (S621 to 624).

First, the search unit 550 of the mobile object 100 may transmit a search request for an autonomous driving module or one among a plurality of sub-modules (e.g., the context prediction module) to the local server 200-1 connected to the mobile object 100 (S601). At this point, the search unit 550 may transmit data related to the operation of the searched autonomous driving module or one among the plurality of sub-modules (e.g., the context prediction module) to the local server 200. At this point, the transmitted data may be transmitted in a metadata format. In response thereto, the local server 200-1 may confirm whether there exist data and an autonomous driving module or one among a plurality of sub-modules (e.g., the context prediction module) corresponding to the data related to the operation of the autonomous driving module or one among the plurality of sub-modules (e.g., the context prediction module) transmitted by the search unit 550 (S602).

When an autonomous driving module or one among a plurality of sub-modules (e.g., the context prediction module) corresponding to the local server 200-1 and data related to the autonomous driving module or one among the plurality of sub-modules (e.g., the context prediction module) do not exist, the local server 200-1 may request an autonomous driving module or one among a plurality of sub-modules (e.g., the context prediction module) from the central server 250 using metadata (S603). Accordingly, the central server 250 may confirm a DB and confirm whether the requested autonomous driving module or one among the plurality of sub-modules (e.g., the context prediction module) exists (S604). When there exists the autonomous driving module or one among the plurality of sub-modules (e.g., the context prediction module) requested from the central server 250, the central server 250 may provide the autonomous driving module or one among the plurality of sub-modules (e.g., the context prediction module) to the local server 200-1 (S607).

Meanwhile, when an autonomous driving module or one among a plurality of sub-modules (e.g., the context prediction module) requested from the central server 250 does not exist, the central server 250 may request the autonomous driving module or one among the plurality of sub-modules (e.g., context prediction module) from other local servers (200-2, ... 200-n) (S605) and receive the module or sub-module from other local servers (200-2, ... 200-n) (S606).

Thereafter, the central server 250 may provide the autonomous driving module or one among the plurality of sub-modules (e.g., context prediction module) to the local server 200-1 (S607).

The local server 200-1 performs preprocessing on the autonomous driving module or one among the plurality of sub-modules (e.g., the context prediction module) and the data related to the autonomous driving module or one among the plurality of sub-modules (e.g., the context prediction module) (S611), and evaluates whether the data is appropriate (S612). For example, at step S611, the local server 200-1 may perform preprocessing such as noise removal, data normalization, and extraction of necessary features as a refining work for the collected sensor data.

When it is determined that the data is not appropriate as a result of the evaluation at step S612, the local server 200-1 may configure data by performing augmentation and virtualization on the data (S614), and convert the configured data (S615). The data converted in this way may be used to train the autonomous driving module or one among the plurality of sub-modules (e.g., context prediction module) at step S617.

Specifically, at step S614, the local server 200-1 requires a large amount of data for training of the autonomous driving module or one among the plurality of sub-modules (e.g., the context prediction module). Since situations that are unusual or difficult to predict may occur in an actual road environment and driving environment, extreme or rare driving situations that may occur in reality and are difficult to collect data may be virtualized by utilizing a generative learning model, and data on the virtualized environment may be collected. Through this, the autonomous driving system may develop an ability of responding to various scenarios based on contextual information and expand diversity and scope of AI training data. For example, the local server 200-1 may perform data augmentation using artificial intelligence network models such as generative adversarial networks (GANs). The generator may generate virtual data difficult to be distinguished from reality, and the discriminator may be trained to determine whether the data is real or not. The generated virtual data enhances diversity of actual data sets. This may be usefully applied in a situation where data collection is expensive or impossible, such as at night, or in a snowy or rainy environment. In addition, the generated virtual data may be used to evaluate robustness of the model by performing stress tests on the algorithms and artificial intelligence models.

Meanwhile, when it is determined that the data is appropriate as a result of the evaluation at step S612, the local server 200-1 may perform selection on the collected data, and the selected data may be used to train the autonomous driving module or one among the plurality of sub-modules (e.g., context prediction module) at step S617.

Specifically, when new source data are collected, it is sequentially determined whether or not to apply the data to improve the performance of the artificial intelligence model and algorithm SW, or when data groups are formed, data that are helpful in improving performance of the autonomous driving module or one among the plurality of sub-modules (e.g., the context prediction module) may be evaluated and selected from the entire groups and applied. For example, selection of data may select and remove data that may cause confusion as result values are not clearly defined and reliability of the first and second results is similar, or data having high entropy or representing unlabeled data, select and remove data that has a large impact on the autonomous driving module or one among the plurality of sub-modules (e.g., context prediction module), or select and remove data with large errors.

Hereinafter, the operation of learning the autonomous driving module or one among the plurality of sub-modules (e.g., context prediction module) of step S617 is described in detail.

In order to train an autonomous driving module or one among a plurality of sub-modules (e.g., a context prediction module) using data related to autonomous driving, it needs to process using a resource-intensive process, and appropriately allocate and optimize resource usage according to the complexity and scale of the AI training. To this end, the local server 200-1 may process training operations in parallel through mini batches of data or perform hyperparameter search in parallel. In addition, when several works are performed simultaneously, operating costs may be reduced as the throughput of the entire system is increased, waiting time is reduced, and energy efficiency is improved through scheduling.

Since it needs to effectively use resources as the inference process requires a real-time response in an autonomous driving system, the local server 200-1 may appropriately allocate hardware resources such as CPU, GPU, and TPU according to the inference work and optimize the resources to be suitable for the mobile object 100 performing autonomous driving.

In addition, the local server 200-1 may model complex driving environments and situations such as driving environments, traffic laws, and vehicle performance, and increase the efficiency, stability, and accuracy of the final autonomous driving module through the process of redesign, implementation, testing, and quality assurance of a model.

In addition, the local server 200-1 may define autonomous driving situations through a language model, virtualize the driving situation of a corresponding case through a generative artificial intelligence model, and test improved data and performance of the autonomous driving module.

In addition, when redesign and optimization of a model required due to changes in the driving environment or application of new traffic laws are performed, the local server 200-1 may expand the scope of autonomous driving scenarios through the language model and the generative artificial intelligence model, and identify and define specific patterns not observed in existing driving data. In addition, the local server 200-1 may search for existing server data through the defined patterns and autonomous driving scenarios, and generate data that does not exist previously through the generative artificial intelligence model to optimize the data and autonomous driving module.

Meanwhile, the trained autonomous driving module or one among the plurality of sub-modules (e.g., context prediction module) may be provided to the mobile object 100 and installed in the mobile object 100 (S621). In addition, the trained autonomous driving module or one among the plurality of sub-modules (e.g., context prediction module) may be stored in the local server 200-1 (S622) and may be stored in synchronization with the central server 250 (S623, S624).

Specifically, when the autonomous driving module or one among the plurality of sub-modules (e.g., the context prediction module) is provided to the vehicle at step S621, the local server 200-1 may verify compatibility with the existing system of the vehicle. For example, the local server 200-1 may confirm whether it is well integrated with the system components of the existing mobile object and operates normally. Furthermore, the local server 200-1 may distribute improved data and the autonomous driving module or one among the plurality of sub-modules (e.g., the context prediction module) through the wireless firmware update called FOTA technology. FOTA is a technique that allows a vehicle to remotely download and install data for update of software while being connected to the Internet, and enables quickly updates of key functions or security patches of software without interrupting vehicle operation.

According to the present disclosure, an autonomous driving control method and device can be provided, in which an autonomous driving system may analyze environments changing in real time based on a driving path and contextual information and determine a path adaptive to dynamic environments.

In addition, according to the present disclosure, in collecting and providing data and software for an autonomous mobile object, a driving scenario may be generated according to mobile object information, movement information, user and passenger information, information on the infrastructure on the path, driving environment information, and sensor information based on a driving path and contextual information, and an autonomous driving module suitable for the generated driving scenario may be configured.

According to the present disclosure, autonomous driving optimized for a driving environment can be realized by distributing an autonomous driving module suitable for a driving scenario.

The effects that can be obtained from the present disclosure are not limited to the effects mentioned above, and unmentioned other effects will be clearly understood by those skilled in the art from the above description.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. An autonomous driving control method based on contextual information, the method comprising:
determining destination information for a user’s mobile object;
determining autonomous driving performance information indicating an autonomous driving performance of the mobile object;
setting a global path to the destination based on the destination information;
generating a first driving scenario for the global path, and determining environment information based on the first driving scenario and traffic situation information about a traffic volume on the global path;
setting a local path by reflecting the autonomous driving performance information, information on the global path, the environment information, and the traffic situation information;
configuring a second driving scenario by reflecting the local path in the first driving scenario, and determining an autonomous driving execution module including a plurality of sub-models corresponding to the second driving scenario; and
controlling autonomous driving of the mobile object using the autonomous driving execution module including the plurality of sub-models.

2. The autonomous driving control method of claim 1, wherein the setting a global path includes:
confirming a movement pattern or a preference of the user corresponding to the destination information of the user using a global path learning model that has learned the movement pattern or preference of the user based on driving data and location information of the user; and
setting the global path reflecting the movement pattern or preference of the user corresponding to the destination information of the user.

3. The autonomous driving control method of claim 2, wherein the determining environment information and traffic situation information includes
collecting information collected through a plurality of sensor units provided in the mobile object; and
converting the collected information into a text, and configuring the contextual information using the text information.

4. The autonomous driving control method of claim 3, wherein the configuring contextual information includes inputting the text information into a chain-of-thought analysis model and determining a path plan based on a driving scenario output from the chain-of-thought analysis model.

5. The autonomous driving control method of claim 3, wherein the configuring contextual information includes inputting the text information into a language model, and determining information on traffic reports, accident updates, and changes in road conditions analyzed and output in a form of natural language through the language model.

6. The autonomous driving control method of claim 1, wherein the environment information includes at least one among external source data including at least one among data on road congestion information, accident occurrence information, and the like provided by an Intelligent Transport System (ITS), and weather data provided by a weather information system, high-definition map (HD Map) data including at least one among location of lanes, traffic lights, road signs, and intersection configurations, and driving data including nodes of the high-definition map data or links connecting the nodes, and polygons indicating roads or lane areas.

7. The autonomous driving control method of claim 6, wherein the determining environment information and traffic situation information includes:
configuring the external source data, high-definition map data, and driving data as multidimensional data;
converting the multidimensional data into data of a vector format of multi-layer; and
connecting the converted data of a vector format of multi-layer by defining a mutual topological relation.

8. The autonomous driving control method of claim 1, wherein the setting the local path includes:
integrating the autonomous driving performance information, information on the global path, the environment information, and the traffic situation information;
generating at least one candidate local path based on the integrated information; and
selecting one of the at least one candidate local path, and determining the selected path as the local path.

9. The autonomous driving control method of claim 1, wherein the determining the selected path as the local path includes determining dynamic event information among the environment information and the traffic situation information, and selecting one of at least one candidate local path based on the dynamic event information.

10. The autonomous driving control method of claim 1, further comprising
requesting at least one among the plurality of sub-modules corresponding to the second driving scenario to a local server or a central server connected to the mobile object;
receiving at least one of the requested sub-modules from the local server or the central server connected to the mobile object; and
updating at least one of the received sub-modules in the autonomous driving execution module, and loading the updated autonomous driving execution module on the mobile object.

11. The autonomous driving control method of claim 10, wherein the requesting at least one among the plurality of sub-modules includes:
inputting the environment information and the traffic situation information into a metadata recording model, and determining metadata output from the metadata recording model; and
requesting at least one among the plurality of sub-modules using the determined metadata.

12. The autonomous driving control method of claim 1, further comprising generating a virtualized driving situation by inputting the autonomous driving performance information, the environment information, and the traffic situation information into a generative learning model, and collecting virtual environment information and virtual traffic situation information corresponding to the generated virtualized driving situation.

13. The autonomous driving control method of claim 12, wherein the setting the local path further includes setting the local path by further reflecting the virtual environment information and virtual traffic situation information, wherein the virtual environment information and virtual traffic situation information are used to simulate potential road conditions and traffic events.

14. An autonomous driving control device based on contextual information, the device comprising:
a communications unit for exchanging data with a mobile object;
a memory for storing at least one instruction; and
a processor for executing the at least one instruction stored in the memory using the data, wherein
the processor is configured to determine destination information for a user’s mobile object, determine autonomous driving performance information indicating an autonomous driving performance of the mobile object, set a global path to the destination based on the destination information, generate a first driving scenario for the global path, and determine environment information based on the first driving scenario and traffic situation information about a traffic volume on the global path, set a local path by reflecting the autonomous driving performance information, information on the global path, the environment information, and the traffic situation information, configure a second driving scenario by reflecting the local path in the first driving scenario, and determine an autonomous driving execution module including a plurality of sub-models corresponding to the second driving scenario, and control autonomous driving of the mobile object using the autonomous driving execution module including the plurality of sub-models.
